(19) United States
(12) Patent Application Publication
(10) Pub. No.: US 2003/0086334 A1
(43) Pub. Date: May 8, 2003

(54) Safety device for stirring assemblies for application to shelf paint vessels

(76) Inventor: Carlo Desinano, Albairate (IT)

Correspondence Address: James V. Costigan, Esq., HEDMAN & COSTIGAN, P.C., Suite 2003, 1185 Avenue of the Americas, New York, NY, 10036-2646, US

(21) Appl. No.: 10/075,858

(22) Filed: Feb. 13, 2002

(30) Foreign Application Priority Data
Nov. 7, 2001 (IT) MI2001A 002341

(51) Int. Cl. B01F 15/00

(52) U.S. Cl. 366/197; 366/247; 366/605

(57) ABSTRACT

A safety device for stirring assemblies to be applied to shelf paint vessels and the like, comprises a top portion including coupling means for coupling to a top portion of the shelf, comprising driving means, means for arranging and centering a stirring cover, and means for coupling to a bottom portion which is provided for covering an element for supporting the stirring means and all the elements being driven.

### BACKGROUND OF THE INVENTION

The present invention relates to a safety device for stirring assemblies, to be applied to shelf paint vessels and the like.

As is known, the shelf paint vessel stirrers are devices designed for stirring the paint held in a vessel, and, to that end use a driving assembly which transmit the required drive by engaging in a horn fitting, provided on the top portion of the stirring vessel cover.

Prior stirring devices which, during the stirring operation, are operatively driven, do not include any protective means and, accordingly, are very dangerous for the operators.

### SUMMARY OF THE INVENTION

Accordingly, the aim of the present invention is to provide a safety device which can be used with a lot of different stirring assemblies, to be applied to shelf paint vessels and the like.

Within the scope of the above mentioned aim, a main object of the present invention is to provide such a safety device, which is adapted to protect all the driven elements of the stirring assembly and, accordingly, all the potentially dangerous elements.

Another object of the present invention is to provide such a safety device which can be perfectly integrated in the stirring assembly, and which is adapted to improve the operation of said stirring assembly.

Yet another object of the present invention is to provide such a safety device which is very advantageous from a mere economic standpoint and which, accordingly, can be broadly used, while providing very satisfactory safety advantages.

According to one aspect of the present invention, the above mentioned aim and objects, as well as yet other objects, which will become more apparent hereinafter, are achieved by a safety device for stirring assemblies, to be applied to shelf paint vessels, characterized in that said safety device comprises a top portion having coupling means for coupling to a top part of a shelf, comprising driving means, mans for locating and centering the stirring cover, and further coupling means for coupling to a bottom portion, provided for covering a supporting element for supporting stirring means and all the provided driven elements.

### BRIEF DESCRIPTION OF THE DRAWINGS

Further characteristics and advantages of the present invention will become more apparent hereinafter from the following detailed disclosure of a preferred, though not exclusive, embodiment thereof, which is illustrated, by way of an indicative, but not limitative, example, in the accompanying drawings, where:

FIG. 1 is an elevation cross-sectioned view of a stirring apparatus including the safety device according to the present invention;

FIG. 2 is a further elevation view of the safety device according to the invention and the stirring assembly associated therewith; and

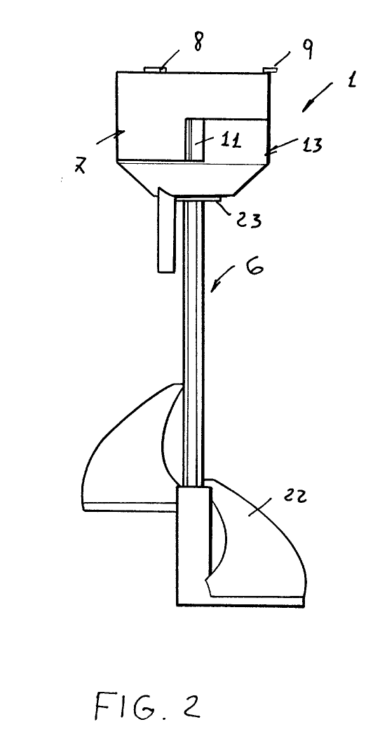

FIG. 3 is a further elevation exploded view illustrating the safety device according to the invention and the stirring assembly associated therewith.

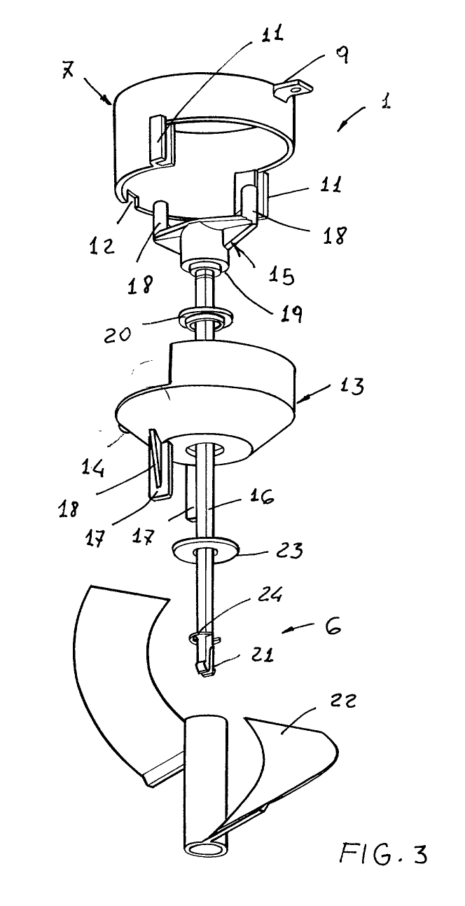

### DESCRIPTION OF THE PREFERRED EMBODIMENT

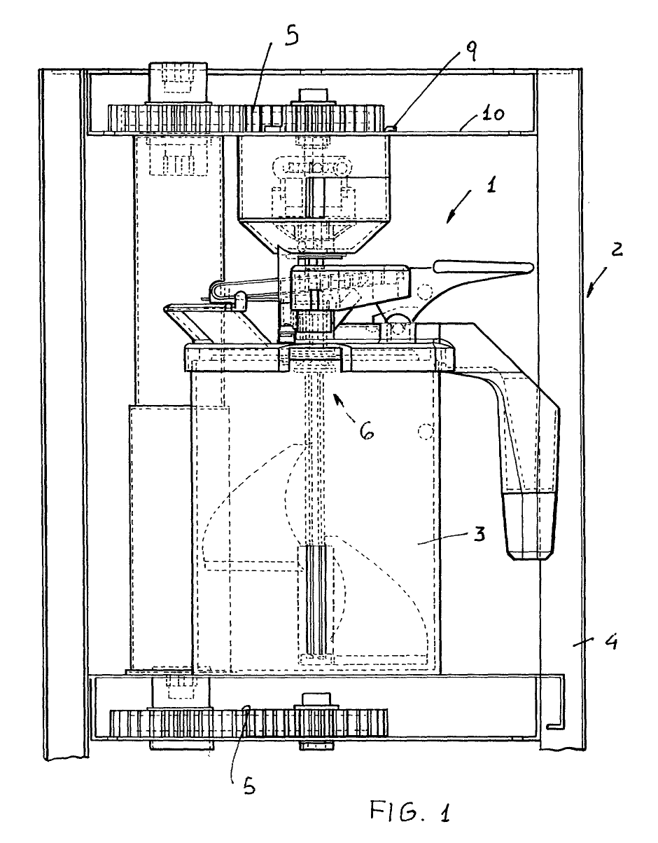

With reference to the number references of the above mentioned figures, the stirring device according to the invention, which has been generally indicated by the reference number 1, can be used in a module 2, comprising a vessel 3, containing a paint or other material, and which can be used on a specifically designed shelf, generally indicated by the reference number 4 in FIG. 1, including driving means 5, for driving a stirring assembly 6, in a per se known manner.

In the embodiment herein shown, the safety device 1 is integrated with the stirring assembly 6, as it will be disclosed in a more detailed manner hereinafter.

The safety device comprises a top cylindric wall 7, at the upper portion thereof are provided a tooth element 8 and a perforated bracket 9 for coupling and clamping, for example by a self-threading screw, to the top part 10, comprising the driving means 5.

On the side portion of the top cylindric wall two guides 11 are provided, for allowing a stirring cover to be easily located and centered, whereas, at the rear portion of the cylinder, a cut-out or opening 12 is formed, for engaging therein a tooth element 14, formed in a bottom conic portion 13.

The latter covers, for an extension of about 180°, a horn element 15 and, by coupling to the top cylindric portion or wall 7, covers all the driven elements, as it will become more apparent hereinafter.

In the bottom conic portion 13, as stated, is formed said tooth element 14 which, in addition to providing a coupling means for coupling with the top cylindric portion or wall 7, prevents the vessel 3 from turning.

In order to further prevent the bottom conic portion 13 from turning and following the shaft 16 of the stirring cover, on the bottom portion is provided a fork element 17 including a rib 18, counterbiassing the stirring cover so as to prevent any rotary movements, while allowing to compensate for possible height differences of the commercially available paint vessels.

In particular, such a compensation can be performed up to a level of 18 mm.

The horn element 15, comprising the stirring shaft 16, is made as a single piece of a plastics material.

At the top portion are moreover provided two coupling cylinders 18 for connection to the driving mechanism 5.

At the underlying portion, moreover, is provided a recess 19 for housing therein a sintered bush 20, for facilitating the rotary of the shaft with respect to the bottom conic portion 13.

The bush 20 is made of a self-lubricating sintered material, and is rigid with the mentioned stirring horn element.

The stirring shaft 16, in particular, is so designed as to present an hexagonal cross-section and, at its end portion is tapering to a smaller cross-section 21, also of hexagonal configuration, for allowing a stirring fan 22 to be plugged in and properly locked, said stirring fan 22 being clamped by the two tooth elements formed at the bottom end portion of the shaft 16.

A sliding ring nut 23 is arranged on the portion underlying the bottom conic portion 13, for preventing this bottom conic portion from contacting a seeger ring element 24, allowing the bottom conic portion 13 to be connected and clamped with respect to said horn element 15.

It has been found that the invention fully achieves the intended aim and objects.

In fact, the invention has provided a safety device which can be used with a lot of different stirring assemblies, to be applied to shelf paint vessels and the like, to safely protect the operators from possible interferences against the driven or movable elements.

In practicing the invention, the used materials, as well as the size and shapes of the several elements constituting the subject device, can be any, depending on the requirements and the status of the art.

1. A safety device for stirring assemblies, to be applied to shelf paint vessels, characterized in that said safety device comprises a top portion having coupling means for coupling to a top part of a shelf, comprising driving means, mans for locating and centering the stirring cover, and further coupling means for coupling to a bottom portion, provided for covering a supporting element for supporting stirring means and all the provided driven elements.

2. A safety device, according to claim 1, characterized in that the top portion comprises a top cylindric portion having an upper part on which are formed a tooth element and a perforated bracket for coupling and clamping said top portion, for example by a self-threading screw, to the top construction comprising the driving means.

3. Safety device, according to claim 2, characterized in that on the side portion of the top cylindric portion are formed two guides allowing said stirring cover to be easily arranged and centered, whereas, at the rear part of said top cylindric portion is formed an opening or cut-out for engaging therein a tooth element formed in a bottom conic portion of said safety device.

4. A safety device, according to claim 3, characterized in that said bottom conic portion covers, for an extension of about 180°, a horn element constituting a part of the stirring means and covering, in cooperation with said top cylindric portion, all the driven or movable elements of said safety device.

5. A safety device, according to claim 3, characterized in that in said bottom conic portion is provided a tooth element which, in addition to allowing said bottom conic portion to be coupled to said top cylindric portion, prevents the paint vessel from turning.

6. A safety device, according to claim 5, characterized in that, for preventing the bottom conic portion from turning and following the shaft of the stirring cover, a fork element is provided at the bottom part of said safety device, said fork element having a rib interfering with said stirring cover, thereby preventing any rotary movements while allowing to compensate for possible height differences of different vessel paints.

7. A safety device, according to claim 6, characterized in that said compensation is achieved up to a level of 18 mm.

8. A safety device, according to claim 4, characterized in that said horn element, which comprises a stirring shaft, is made as a single piece of a plastics material, and that, at a top portion of said horn element are provided two cylinders for coupling to the driving means.

9. A safety device, according to claim 8, characterized in that in a bottom portion of said horn element is formed a recess for engaging therein a sintered bush for facilitating the rotary movement of said stirring shaft with respect to said bottom conic portion.

10. A safety device, according to claim 9, characterized in that said sintered bush is made of a sintered auto-lubricating material and is rigid with said stirring horn element.

11. A safety device, according to claim 8, characterized in that said stirring shaft has a hexagonal cross-section and at a bottom portion thereof is tapering to a smaller cross-section, of hexagonal configuration, for allowing a stirring fan to be plugged-in and locked, said stirring fan being clamped by said two tooth elements formed at the bottom end portion of said stirring shaft.

12. A safety device, according to claim 11, characterized in that a sliding ring nut is arranged at a portion of said stirring device underlying said bottom conic portion, for preventing said bottom conic portion from contacting a seeger ring element allowing said bottom conic portion to be coupled and clamped to said horn element.
